(19) United States
(12) Patent Application Publication
(10) Pub. No.: US 2008/0301038 A1
(43) Pub. Date: Dec. 4, 2008

(54) System and Method for Sharing and Allocating Financial Risk Associated with a Loan

(75) Inventors: Wiliam J. Anderson, Redwood City, CA (US); Edward D. Van Wesep, Chapel Hill, NC (US)

Correspondence Address: FENWICK & WEST LLP, SILICON VALLEY CENTER, 801 CALIFORNIA STREET, MOUNTAIN VIEW, CA, 94041, US

(73) Assignee: RISK ALLOCATION SYSTEMS, Redwood City, CA (US)

(21) Appl. No.: 12/133,239

(22) Filed: Jun. 4, 2008

Related U.S. Application Data
(60) Provisional application No. 60/941,857, filed on Jun. 4, 2007.

(51) Int. Cl. G06Q 40/00

(52) U.S. Cl. 705/38

(57) ABSTRACT

An application for a loan comprising information about a buyer is received. An amount of funds to be contributed to the holdback pool by the seller based on the information about the buyer is determined. Approval of the amount of funds is received from the seller. The application for the loan is approved responsive to the approval from the seller.

### BACKGROUND OF THE INVENTION

1. Field of the Invention

This invention pertains in general to mechanisms for allocating financial risk associated with loan between sellers of goods or services and providers of loans.

2. Description of the Related Art

Buyers of expensive goods and services like automobiles, furniture, voluntary medical procedures, equipment, homes, etc. frequently require financing or loans. Often the seller of the goods or services is unable to provide loans to potential buyers of their goods or services. Accordingly, the buyers are required to seek a loan from a loan provider (“lender”). With any loan there is an associated financial risk to the lender. Financial risk encompasses both the risk of financial loss on a loan and the uncertainty associated with the risk of financial loss on a loan. Financial loss on a loan can represent a net financial loss on the loan or a financial loss relative to the lender's expected rate of return on a loan. Sources of financial risk include but are not limited to: the risk that the buyer will fail to make payments resulting in delinquency or default of the loan, risk of failure to recover collateral on the loan, risk of pre-payment of the loan, risk of inflation, risk of devaluation of the collateral and risk of failure of insurance. The financial risk associated with a loan is commonly evaluated by the lender using factors such as the buyer's credit score.

If the financial risk of loss associated with a loan is perceived to be too great, the buyer may not be able to secure a loan and the transaction will not occur. The loss of transactions due to risk of financial loss associated with loans creates a conflict of interest between the seller and the lender. Due to the financial loss associated with loans, most lenders only grant loans with the lowest associated risk of financial loss. Conversely, the sellers wish to achieve the highest volume of sales possible regardless of the risk of financial loss associated with loans used to finance their sales. This misalignment of preferences limits the effectiveness of partnerships between the seller and the lender.

Accordingly, there is a need in the art for mechanisms for increasing the volume of loans provided while ensuring that the lender's risk of financial loss due to loan non-payment is minimized.

### BRIEF SUMMARY

The above and other needs are met by methods of allocating financial risk associated with a loan between a loan provider and a seller of a good or service.

One aspect provides a method for processing a loan. An application for a loan comprising information about a buyer is received. An amount of funds to be contributed to the holdback pool by the seller based on the information about the buyer is determined. Approval of the amount of funds is received from the seller. The application for the loan is approved responsive to the approval from the seller.

Another aspect provides a computer system for processing a loan. The computer system comprises a reporting module for receiving an application for a loan comprising information about a buyer from a seller system. The reporting module is adapted for communication with a loan provider system and the seller system. The computer system further comprises a holdback module for determining a holdback value representing a risk of non-payment associated with the loan based on the information about the buyer and determining an amount of funds to be contributed to the holdback pool by the seller system based on the holdback value. The holdback module is adapted for communication with the reporting module.

The features and advantages described in this summary and the following detailed description are not all-inclusive. Many additional features and advantages will be apparent to one of ordinary skill in the art in view of the drawings, specification, and claims hereof.

### BRIEF DESCRIPTION OF THE DRAWINGS

FIG. 1 is a high-level block diagram of a computing environment according to one embodiment of the present invention.

FIG. 2 is a high-level block diagram illustrating an embodiment of a computer 200 for use in a risk allocation server according to the present invention.

FIG. 3 is a high level block diagram of the risk allocation system according to one embodiment of the present invention.

FIG. 4 is a high-level block diagram illustrating a risk allocation server according to one embodiment of the present invention.

FIG. 5 is a flowchart illustrating a process for transmission of funds to a lender according to one embodiment of the present invention.

FIG. 6 is a flowchart of a method for using the holdback pool according to one embodiment of the present invention.

FIG. 7 is a flowchart of a method for generating holdback values according to one embodiment of the present invention.

The figures depict an embodiment of the present invention for purposes of illustration only. One skilled in the art will readily recognize from the following description that alternative embodiments of the structures and methods illustrated herein may be employed without departing from the principles of the invention described herein.

### DETAILED DESCRIPTION

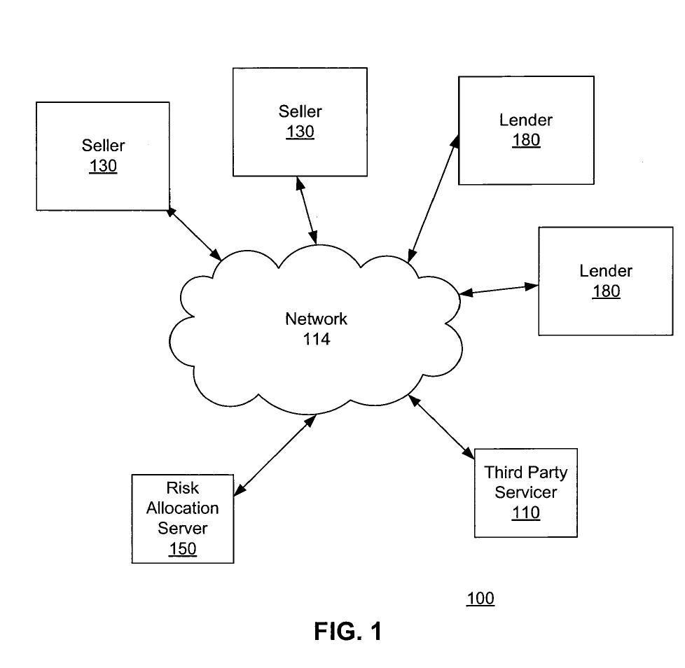

A risk allocation system 100 is described. In the following description, for purposes of explanation, numerous specific details are set forth in order to provide a thorough understanding of the invention. It will be apparent, however, to one skilled in the art that the invention can be practiced without these specific details. In other instances, structures and devices are shown in block diagram form in order to avoid obscuring the invention. For example, the present invention is described in one embodiment below with reference to FIG. 1.

Reference in the specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment. In particular the present invention is described below in the context of two distinct architectures and some of the components are operable in both architectures while others are not.

Some portions of the detailed descriptions that follow are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The present invention also relates to an apparatus for performing the operations herein. This apparatus may be specially constructed for the required purposes, or it may comprise a general-purpose computer selectively activated or reconfigured by a computer program stored in the computer. Such a computer program may be stored in a computer readable storage medium, such as, but is not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, each coupled to a computer system bus.

Finally, the algorithms and displays presented herein are not inherently related to any particular computer or other apparatus. Various general-purpose systems may be used with programs in accordance with the teachings herein, or it may prove convenient to construct more specialized apparatus to perform the required method steps. The required structure for a variety of these systems will appear from the description below. In addition, the present invention is described with reference to any particular programming language. It will be appreciated that a variety of programming languages may be used to implement the teachings of the invention as described herein.

FIG. 1 is a high-level block diagram of a risk allocation system 100 according to one embodiment. FIG. 1 illustrates a risk allocation server 150, a plurality of sellers 130, a plurality of lenders 180 and a loan servicer 110 connected by a network 114. Only two sellers 130, two lenders 180 and one loan servicer 110 are shown in FIG. 1 in order to simplify and clarify the description. Other embodiments of the risk allocation system 100 can have thousands or millions of sellers 130, lenders 180 and loan servicers 110 connected to the network 114. Alternate embodiments of the present invention may only have one seller 130 and one lender 180.

The risk allocation server 150 interacts with computing systems operated by sellers, lenders and loan servicers via the network 114. These computing systems including the software and routines of the present invention will be referred to throughout this application as sellers 130, lenders 180 and loan servicers 110. The risk allocation server 150 acts as an intermediary between sellers 130 and lenders 180 to provide information and analyses used to make lending decisions. The risk allocation server 150 further provides a mechanism to determine the value of funds used to allocate financial risk associated with loans between the sellers 130 and the lenders 180. “Allocation of financial risk” refers to the contribution of funds by sellers 130 to holdback pools used to compensate for the lender's 180 financial losses associated with loans due to loan non-payment or other events causing the lender 180 to incur financial loss. The term “non-payment” as used herein refers to a delinquency or a default of a loan. The allocation of financial risk enables the lender 180 to provide loans that may otherwise have too great of a financial risk to be profitable for a lender 180. The allocation of financial risk further enables the seller 130 to complete transactions with buyers who may have otherwise been unable to secure a loan.

The risk allocation server 150 allocates financial risk by determining holdback values for loans used to finance the seller's 130 goods or services. The holdback values specify an amount of funds that the seller 130 contributes to a holdback pool when a loan is granted. The risk allocation server 150 uses loan application information received from the seller 130 to approve a loan for a buyer and/or determine whether allocation of financial risk to the seller 130 is required for loan approval. In one embodiment, the risk allocation server 150 determines holdback values based on information associated with the seller 130 and the information included in the loan applications if the loan applications indicate allocation of financial risk is required for loan approval. In alternate embodiments, the risk allocation server 150 determines the holdback values without first determining whether financial risk allocation is required. The funds in the holdback pool are used in part to repay the lender 180 the financial loss (e.g. loss of loan interest and/or loss of principle) associated with a loan in the event of loan non-payment or other factors resulting in financial loss. The risk allocation server 150 determines a holdback value for a loan based on information associated with the buyer, the seller 130 and the goods or services financed by the loan.

The seller 130 is a computer system used by a seller of goods or services to interact with the risk allocation server 150 in order to provide loans to buyers. The seller 130 transmits loan applications including information about buyers and the loans to the risk allocation server 150. The seller 130 contributes funds equal to the determined holdback values to a holdback pool when the loans are granted. After all of the loans associated with a holdback pool all have either been paid in full or defaulted, the seller 130 receives the remaining funds in the holdback pool from the loan servicer 110 or the risk allocation server 150.

Once a loan has been approved and processed, the risk allocation server 150 provides loan information to a loan servicer 110. In one embodiment, the loan servicer 110 is a third party relative to the seller 130 and the lender 180. In some embodiments, the loan servicer 110 may be associated with the same entity as the risk allocation server 150. The loan servicer 110 collects loan payments from the buyer. In the event of loan non-payment, the loan servicer 110 also recovers and monetizes the goods purchased with the loan. The loan servicer 110 determines a net loss value based in part on the recovery and monetization of the goods. In some embodiments, the loan servicer 110 deducts funds equal to the net loss value from the holdback pool and transmits these funds and the funds produced from the recovery and monetization of the goods to the lender 180. In a preferred embodiment, the risk allocation server 150 deducts funds equal to the net loss value from the holdback pool and transmits these funds and the funds produced from the recovery and monetization of the goods to the lender 180.

The lender 180 is a computer system used by a provider of loans. The lender 180 receives loan application information from the risk allocation server 150. In alternate embodiments, the lender 180 uses the loan application information to approve a loan for a buyer and/or determine whether allocation of financial risk to the seller 130 is required for loan approval. In some embodiments, the lender 180 may provide a set of criteria to the risk allocation server 150 which specify whether a loan is approved with or without risk allocation. The criteria provided by the lender 180 may be based on information associated with the buyer 130 such as the buyer's credit history. The criteria may also be based on information about the loan such as the loan to value ratio for the loan, the interest rate of the loan or the type of good or service the loan is used to finance. The lender 180 receives loan payments from the third party servicer 110. In the event of a default of a loan in which financial risk has been allocated to the seller 130, the risk allocation server 150 or the loan servicer 110 transmits funds from the holdback pool corresponding in part to the financial loss (i.e. equal to the financial loss or equal to a percentage of the financial loss) on the loan or a fixed amount to the lender 180. According to the embodiment, the holdback pools may be closed after a period of time or remain open indefinitely receiving holdback funds from the seller 130 and transmitting the financial loss funds to the lender 180.

The use of the risk allocation server 150 to allocate lending risk to the seller provides a common incentive to the lender 180 and the seller 130 to maximize the volume of transactions while minimizing the risk of non-payment. As the seller 130 absorbs part of the financial risk associated with loan non-payment through contribution to the holdback pool, the amount of financial risk incurred by the lender 180 is reduced and made predictable. This reduction in financial risk reduces the overall fluctuations in financial gains for loans issued by the lenders 180 and may increase the lender's 180 financial gains on loans given to buyers associated with a higher financial risk. Absorption of financial risk enables the seller 130 to complete additional transactions with buyers normally not able to obtain financing, thus increasing the seller's 130 financial gains. Through absorption of financial risk, the seller 130 may also be able to provide buyers with reduced rates of interest, thus increasing the seller's 130 volume of transactions.

The network 114 represents the communication pathways between the risk allocation server 150, the sellers 130, the lenders 180 and the third party servicers 110. In one embodiment, the network 114 is the Internet. The network 114 can also utilize dedicated or private communications links that are not necessarily part of the Internet. In one embodiment, the network 114 uses standard communications technologies and/or protocols. Thus, the network 114 can include links using technologies such as Ethernet, 802.11, integrated services digital network (ISDN), digital subscriber line (DSL), asynchronous transfer mode (ATM), etc. Similarly, the networking protocols used on the network 114 can include the transmission control protocol/Internet protocol (TCP/IP), the hypertext transport protocol (HTTP), the simple mail transfer protocol (SMTP), the file transfer protocol (FTP), etc. In some embodiments, the network 114 can also be a wireless network implemented using standard wireless networks such as wireless local area network (WLAN) or mobile device networks such as Global System for Mobile Communications (GSM). The data exchanged over the network 114 can be represented using technologies and/or formats including the hypertext markup language (HTML), the extensible markup language (XML), etc. In addition, all or some of links can be encrypted using conventional encryption technologies such as the secure sockets layer (SSL), Secure HTTP and/or virtual private networks (VPNs). In another embodiment, the entities can use custom and/or dedicated data communications technologies instead of, or in addition to, the ones described above.

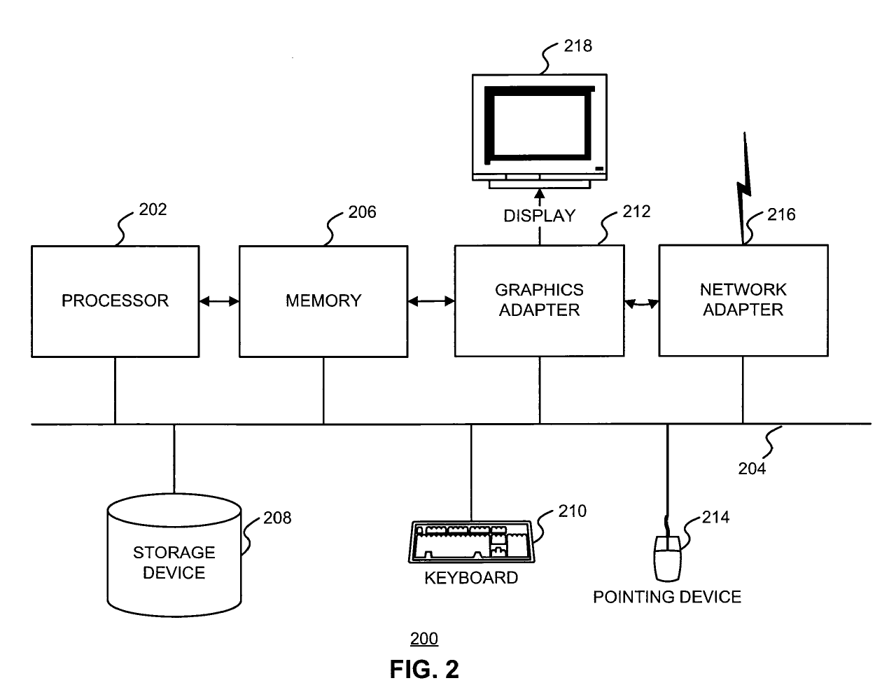

FIG. 2 is a high-level block diagram illustrating a typical computer 200 for use as a risk allocation server 150, a seller 130, a lender 180 or a third party servicer 110. Illustrated are a processor 202 coupled to a bus 204. Also coupled to the bus 204 are a memory 206, a storage device 208, a keyboard 210, a graphics adapter 212, a pointing device 214 and a network adapter 216. A display 218 is coupled to the graphics adapter 212.

The processor 202 may be any general-purpose processor such as an INTEL x86 compatible-CPU. The storage device 208 is, in one embodiment, a hard disk drive but can also be any other device capable of storing data, such as a writeable compact disk (CD) or DVD, or a solid-state memory device. The memory 206 may be, for example, firmware, read-only memory (ROM), non-volatile random access memory (NVRAM), and/or RAM, and holds instructions and data used by the processor 202. The pointing device 214 may be a mouse, track ball, or other type of pointing device, and is used in combination with the keyboard 210 to input data into the computer 200. The graphics adapter 212 displays images and other information on the display 218. The network adapter 216 couples the computer 200 to the network 114.

As is known in the art, the computer 200 is adapted to execute computer program modules. As used herein, the term “module” refers to computer program logic and/or data for providing the specified functionality. A module can be implemented in hardware, firmware, and/or software. In one embodiment, the modules are stored on the storage device 208, loaded into the memory 206, and executed by the processor 202.

The types of computers 200 utilized by the entities in FIG. 1 can vary depending upon the embodiment and the processing power utilized by the entity. For example, a seller 130 that is a mobile telephone typically has limited processing power, a small display 218, and might lack a pointing device 214. The risk allocation server 150, in contrast, may comprise multiple blade servers working together to provide the functionality described herein with or without a display 218.

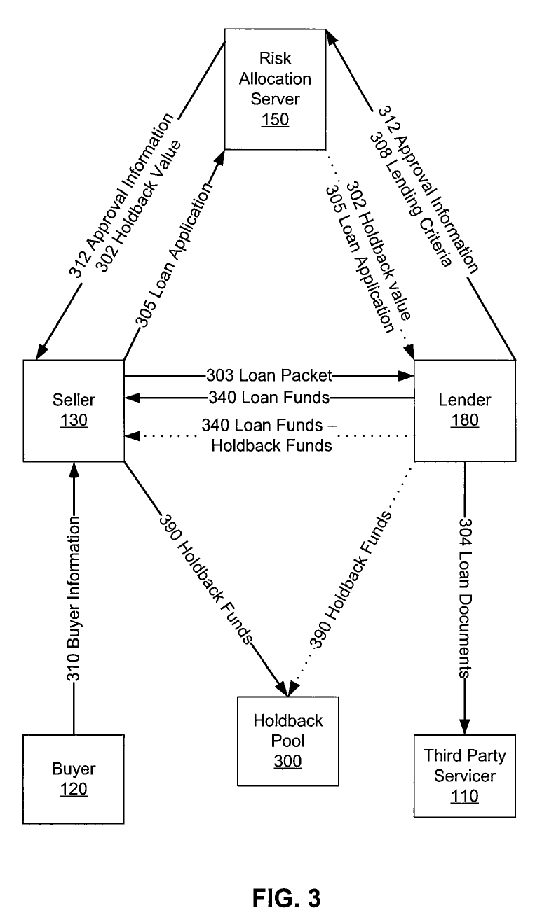

FIG. 3 is a high level block diagram illustrating the transmission of information and funds between the risk allocation server 150, sellers 130, lenders 180 and third party servicers 110 over the network 114 according to one embodiment. The majority of the discussion of the present invention herein is directed to embodiments in which information is transmitted electronically through the network 114. In alternate embodiments of the present invention, information or funds may be transmitted physically, for example, using paper forms to transmit information or currency to transmit funds. Those of skill in the art will recognize that other embodiments can have different and/or other entities than the ones described here, and that information and funds may be transmitted in a different manner. In addition, the functions ascribed to the risk allocation server 150 can be performed by multiple servers.

A prospective buyer 120 of a good or service provides buyer information 310 to a seller 130 of the good or service. In most embodiments, the buyer 120 may provide the buyer information directly to the seller 130 (e.g. at the seller's 130 storefront). In alternate embodiments, the buyer 120 may also provide the buyer information to the seller 130 through the network 114. Buyer information 310 can include the buyer's 120: employment history, home ownership, credit score, personal information, driving history, social security number, driver's license number or any other type of information that can be used to accurately identify the buyer 120 and/or evaluate the risk of non-payment for a loan granted to the buyer 120. The seller 130 electronically transmits a loan application 305 including the buyer information 310 to the risk allocation server 150 through the network 114. The loan application 305 further includes information regarding the seller 130, the value of the good or service, the value of the loan, a preferred interest rate of the loan specified by the seller 130 and information regarding the good or service such as the type or make of the good or service.

In a preferred embodiment, the risk allocation server 150 compares the loan application 305 to lending criteria 308 specified by each of the lenders 180 to determine whether loan applications can be approved with or without financial risk allocation. In alternate embodiments, the lending criteria 308 may be specified or determined by the risk allocation server 150. Lending criteria 308 specified by the lenders 180 may include minimum and maximum values associated with buyer and loan information for loan approval with and without financial risk allocation. For example, the lending criteria 308 may specify a minimum buyer credit score, such as a Fair Isaac Corporation (FICO) score of 660, for loan approval without financial risk allocation and a minimum FICO score of 600 for loan approval with financial risk allocation. Likewise, lending criteria 308 may specify a maximum loan to value of goods ratio of 1:1 for approval with financial risk allocation and a maximum loan to value of goods ratio of 0.8:1 for approval without financial risk allocation. In a preferred embodiment, if the loan application 305 fulfills the lending criteria 308 defined by a lender 180 for approval without risk allocation, the loan application 305 is approved. In alternate embodiments, the loan application 305 transmitted to the lender 180 for final approval.

According to the preferred interest rate specified in the loan application 305, the lender's criteria 308 may specify that financial risk allocation is necessary for loan applications 305 that may otherwise be approved without financial risk allocation. For example, a loan application 305 indicating good buyer credit scores and a high loan to value of goods ratio may require risk allocation due to a preferred interest rate that is beneath a minimum interest rate specified by the lending criteria.

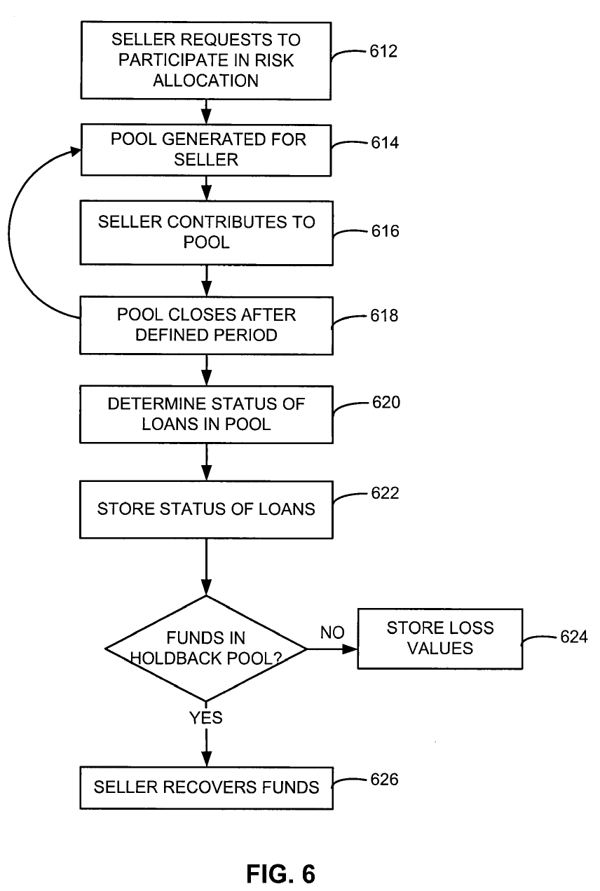

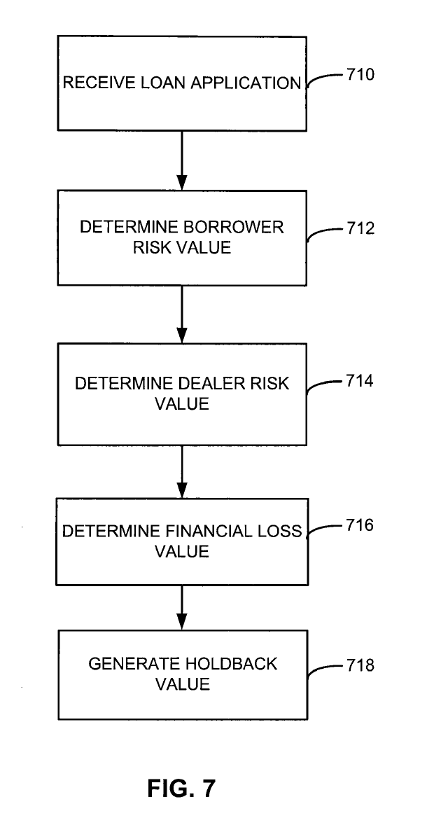

If the lending criteria 308 indicate that the loan application 305 can be approved with financial risk allocated to the seller 130, the risk allocation server 150 generates a holdback value 302. In an alternate embodiment, the risk allocation server 1590 generates a holdback value 302 for all loan applications 305 without first comparing the loan application 305 to lending criteria 308 specified the lenders 180. The holdback value 302 specifies an amount of holdback funds 390 that a seller 130 will contribute to the holdback pool 300 if the loan is approved by the lender 180 and granted. Holdback value 302 generation and seller 130 contribution of holdback funds 390 to holdback pools 300 are discussed in detail with respect to FIGS. 7 and 6 respectively. In a preferred embodiment, the loans with financial risk are automatically approved by the risk allocation server 150. In alternate embodiments, the holdback value 302 is transmitted with the loan application 305 to the lender 180 for approval. If the lender 180 approves of the loan application 305 and holdback value 302, the lender 180 transmits approval information 312 to seller 130 via the risk allocation server 150.

Upon approval, the seller 130 transmits a loan packet 303 directly to the lender 180. The loan packet 303 contains a formal version of the loan application 305 and associated legal and financial documents. If the approval of the loan is conditioned on financial risk allocation, the seller 130 contributes holdback funds 390 equal to the holdback value 302 to a holdback pool 300. The lender 180 then transmits the loan funds 340 to the seller 130. In alternate embodiments, the lender may transmit the holdback funds 390 directly to the holdback pool 300 and transmit the loan funds minus the holdback funds 340 to the seller. The lender 180 further transmits the loan documents 304 specifying the financial and legal terms of the loan to the third party servicer 110.

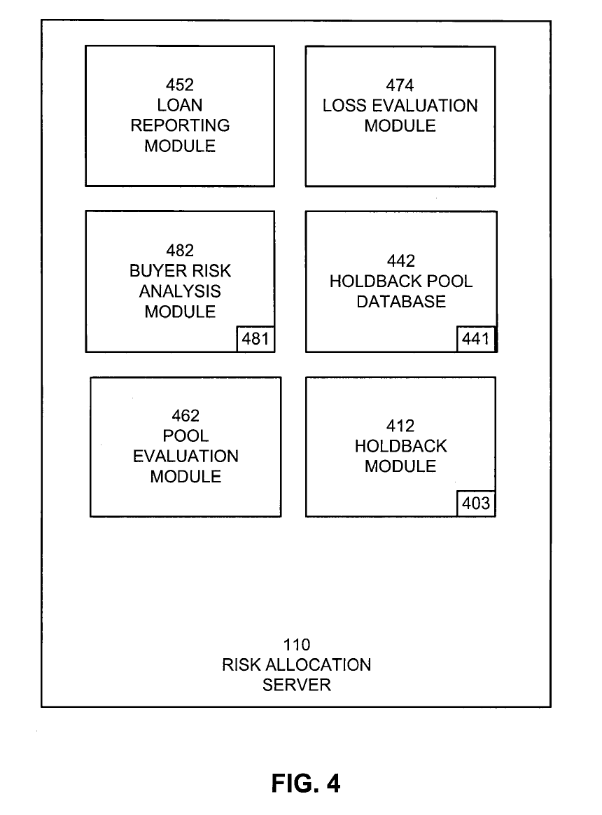

FIG. 4 is a high-level block diagram illustrating a detailed view of the risk allocation server 150 according to one embodiment. As shown in FIG. 4, the risk allocation server 150 includes multiple modules. Those of skill in the art will recognize that other embodiments of the risk allocation server 150 can have different and/or other modules than the ones described here, and that the functionalities can be distributed among the modules in a different manner.

The loan reporting module 452 communicates with the lenders 180 and sellers 130 to transmit information between the lenders 180 and the sellers 130. The loan reporting module 452 receives and transmits loan applications 305 and approval information 312. The loan reporting module 452 receives lending criteria 308 specified by the lenders 180 and stores the lending criteria for use by the risk allocation server 150. The loan reporting module 452 transmits the loan application 305 and approval information 312 to the holdback module 412, the pool evaluation module 462, the loss evaluation module 474 and the holdback pool database 442. The loan reporting module 452 further transmits information generated by the risk allocation server 150 such as holdback values 302 to the lenders 180 and the sellers 130. In some embodiments, the loan reporting module 452 may also transmit other information generated by the risk allocation server 150 such as values indicating predicted internal rate of return (IRR) based on lending criteria 308 received from the lender 180.

The buyer risk analysis module 482 determines a buyer risk value based on buyer information 310 included in a loan application 305. The buyer risk value indicates the financial risk for a loan associated with a buyer 120. According to the embodiment, the buyer risk value may be a single value or incorporate multiple buyer risk values. The buyer risk analysis module 482 receives loan applications 305 including buyer information 310 from the loan reporting module 452. In some embodiments, the buyer risk analysis module 482 generates the buyer risk value by applying a buyer risk underwriting model 481 to the buyer information 310. In one embodiment, the buyer risk underwriting model 481 specifies a set of coefficients used to weigh different types of buyer information 310 in determining the buyer risk value. The set of coefficients represent the predicative value of the different types of buyer information 310 for determining the risk of non-payment associated with a buyer 120.

The buyer risk analysis module 482 determines the set of coefficients for the different types of buyer information by applying regression-based modeling to historic loan data. The historic loan data indicates whether buyers associated with the different buyer information have paid their loans in full or have loans that have entered non-payment such as delinquency or default. According to the embodiment, the historic loan data may correspond in part or in full to the data stored in the holdback pool database 442. In some embodiments, the historic loan data may include simulated historic loan data 441 generated using techniques such as Monte Carlo modeling stored in the holdback pool database 452.

In alternate embodiments, non-regression based techniques such as machine learning, maximum likelihood, generalized method of moments and non-parametric techniques are used to generate the buyer risk underwriting model 481. Suitable alternative techniques for generating buyer risk underwriting models 481 are well known to those skilled in the art.

According to the embodiment, the buyer risk analysis module 482 segments the historic loan data by the dates of the loan or payments and analyzes the historic loan data in order to adjust for economic factors which may influence loan payment. In some embodiments, the buyer risk analysis module 482 partitions the historic loan data into a set of time periods and determines the set of coefficients for each time period separately. The buyer risk analysis module 482 adjusts the set of coefficients for each time period. In some embodiments, the buyer risk analysis module 482 determines a buyer risk underwriting model 481 based on plotting the coefficients over time.

In a specific embodiment, the buyer risk analysis module 482 determines a set of coefficients for the different types of buyer information 310 by applying regression based techniques to historic loan data partitioned into one month periods. The different types of buyer information 310 may include: credit history, income and employment history, a number of bankruptcies associated with the buyer, etc. The buyer risk analysis module 482 then calculates “unconditional default” and “pre-payment” curves for use as a buyer risk underwriting module 481. These curves display the probability, when a loan is originated, that said loan associated with the buyer 120 will default or pre-pay in a particular month. For each month the probability of default and the probability of pre-payment is determined based on the different types of buyer information 310.

The loss evaluation module 474 determines a financial loss value indicating a predicted amount of financial loss that is specific to the goods or services indicated in the loan application 305. The loss evaluation module 474 further determines the financial loss value based on the likelihood of recovery of the goods and a cost associated with contracting the loan servicer 110 to recover and resell the goods.

For durable goods such as automobiles and furniture, the loss evaluation module 474 determines the financial loss value based on an estimated amount of funds that can be obtained through recovery and sale of the goods if the loan defaults. In one embodiment, the loss evaluation module 474 determines the financial loss value based on a rate of depreciation of the durable goods. The loss evaluation module 474 determines a rate of depreciation based on factors influencing the durability of the goods such as the type, brand, or make of the goods. The rate of depreciation may also be determined based on factors which indicate a likelihood of damage to the durable goods such as the geographic area of the loan or buyer information 310. For instance, buyer information 310 indicating a history of reckless driving may cause the estimated rate of depreciation for a vehicle and associated financial loss value to increase.

In some embodiments, the loss evaluation module 474 may further determine the financial loss value based on historic loan data stored in the holdback pool database 442 indicating the amount of funds obtained through the recovery and sale of durable goods. The loss evaluation module 474 may further determine the financial loss value on economic factors influencing the amount of funds obtained through the recovery and sale of durable goods.

According to the embodiment, the financial loss value may be further based on factors relating to financial loss on a loan other than loan non-payment. Other factors relating to financial loss on a loan include but are not limited to: servicing costs on the loan, likelihood of pre-payment on loans, inflation risks associated with a loan, failure of insurance on a loan, opportunity costs on a loan and the cost of the capital on a loan. For instance, the financial loss value may be based on amount of funds representing interest on the loan that is lost during the recovery and resale of the good. According to the embodiment, the loss evaluation module 474 may determine the financial loss value for a good or a home loan based on the amount of money the loan is for, the interest rate of the loan and resale market factors pertaining to the good. Estimated losses during the recovery period may depend on average time to resale in the secondary market, interest rates, asset price appreciation or depreciation rates, bid-ask spreads, or other factors.

The holdback pool database 442 stores information for loans in which financial risk has been allocated to the seller 130. The holdback pool database 442 stores all information about the loan including: the date of the loan, the holdback value 302 of the loan, the holdback pool 300 associated with the loan, the seller 130, buyer information, terms of the loan, amount of the loan and all loan application information. The holdback pool database 442 further stores loan payment information provided by the third party servicers 110 including data indicating loan non-payment, the outstanding principle of loans associated with non-payment and net loss values associated with loan non-payment. The holdback pool database 442 may further store values indicating the lender's 180 financial loss in the event that the funds in a holdback pool 300 for a loan are insufficient to cover the net loss values associated with the loan. In some embodiments, the holdback pool database 442 stores simulated historical loan data 441 generated using simulation techniques such as Monte Carlo modeling.

The pool evaluation module 462 determines a seller risk value indicating a risk of loan loss specific to loans associated with the seller 130. The seller risk value is used by the holdback module 412 to determine holdback values for the seller 130. Consequently, the seller risk value indicates the likelihood that the funds from the seller's holdback pool used to cover loan loss will exceed the amount of funds in the seller's holdback pool 300. The majority of the discussion herein is directed to embodiments in which the buyer risk values and seller risk values are determined independently by the buyer risk analysis module 482 and the pool evaluation module 462. However, it is important to note that in alternate embodiments, dealer risk values may depend in part on information used to determine the buyer risk underwriting model 481 and the buyer risk value. Conversely, information associated with the seller 130 may be used to determine buyer risk values for a loan. In these embodiments, different types of buyer information 310 may have different strengths of correlation to seller risk values associated with different sellers 130. For example, it may be determined the some sellers 130 have a decreased risk of loan loss based on buyer credit scores relative to other sellers 130.

The pool evaluation module 462 communicates with the holdback pool database 442 to identify historic loan data indicating the number of loans associated with the seller 130 that have been paid or are in good standing and the number of loans associated with the seller 130 that have defaulted. The pool evaluation module 462 further determines a seller risk value indicating a rate of loan non-payment for loans associated with the seller 130. The pool evaluation module 462 may determine the seller risk value based on the percentage of loans associated with the seller 130 that have had non-payment events or using regression-based techniques.

According to the embodiment, the pool evaluation module 462 can determine a single seller risk value from all historic loan data associated with the seller 130 or combine individual risk values generated from historic loan data associated with different holdback pools. In some embodiments, the pool evaluation module 462 determines the variation over time of historic loan data in order to adjust for economic factors which may influence loan payment. In one embodiment, the pool evaluation module 462 then adjusts the individual seller risk values associated with different holdback pools based on the dates associated with the holdback pools before combining the individual seller risk value to generate the seller risk value. In some embodiments, the pool evaluation module 462 may partition the historic loan data from different holdback pools into smaller time intervals (e.g. monthly intervals) and determine individual seller risk value for each time interval before adjusting and combining the values.

Based on the determined seller risk values, the pool evaluation module 462 determines other financial risk allocation information specific to the seller 130 such as the amount of funds necessary for a seller 130 to start a holdback pool 300.

The holdback module 412 evaluates the loan application 305 information to determine whether financial risk allocation is necessary for loan approval. The holdback module 412 compares the loan application 305 information to lending criteria 308 specified by the lenders 180 to determine whether the loan application 305 can be approved with or without financial risk allocation.

If financial risk allocation is necessary for loan approval, the holdback module 412 determines holdback values based on the financial loss value, the seller risk value and the buyer risk value generated based on the loan application 305 data. The holdback module 412 may combine the financial loss value, the seller risk value and the buyer risk value in any way in order to determine the holdback values for a particular loan. In one embodiment, the holdback module 412 combines the financial loss value, the seller risk value and the buyer risk value using the holdback underwriting model 403 specifying coefficients used to weight the financial loss value, the seller risk value and the buyer risk value. According to the embodiment, the holdback module 412 may combine the financial loss value, the seller risk value and the buyer risk value by adding or multiplying the values. For instance, the buyer risk value and/or seller risk may be multipliers (i.e. 0.9 for a good dealer, 1.1 for a bad) for the financial loss value which decreases or increases (respectively) the required holdback for a loan.

In some embodiments, the holdback module 312 determines the holdback underwriting model 403 based on historical loan data from the holdback pool database 442. In a specific embodiment, the holdback module 312 determines “default” and “pre-payment” curves based on information indicated in the loan applications associated with the historical loan data for use as the holdback underwriting module 403. These curves indicate the probability that loans will default or pre-pay at each month of a loan. For each month, the probability of loan non-payment is multiplied by an expected financial loss of default at the month. The expected financial loss of may correspond to or be based on the same variables as the financial loss value. According to the embodiment, the holdback module 312 also may indicate expected prepayments, interest payments, principle payments and default payments over the history of a loan.

The holdback module 412 communicates with the loan reporting module 452 to receive the loan application 305 data. The holdback module 412 further communicates with the loss evaluation module 474, the buyer risk analysis module 482 and the pool evaluation module to receive the financial loss value, the buyer risk value and the seller risk value respectively. The holdback module 412 transmits the determined holdback value to the loan reporting module 452 for reporting to the seller 130 and the lender 180.

In some embodiments the holdback module 412 further determines a predicted internal rate of return (IRR) based on lending criteria 308 specified by the lenders 180. The holdback module 412 communicates with the holdback pool database 442 to select information about a set of loans satisfying the lending criteria 308 specified by the lenders 180. The holdback module 412 then can determine current and expected lender loss values for the set of loans satisfying the lending criteria 308 based on the selected information. The current lender loss value specifies the number of times that the financial loss on a loan associated with non-payment was not covered by the funds in a holdback pool and the value of the financial loss not covered. The expected lender loss value would further include future expected financial losses determined using the holdback underwriting module 403. Based on the lender loss values and other information specified by the lenders including interest rates associated with the lending criteria 308, the holdback module 412 may determine current and predicted internal rates of return associated with the lending criteria 308 specified by the lenders 180.

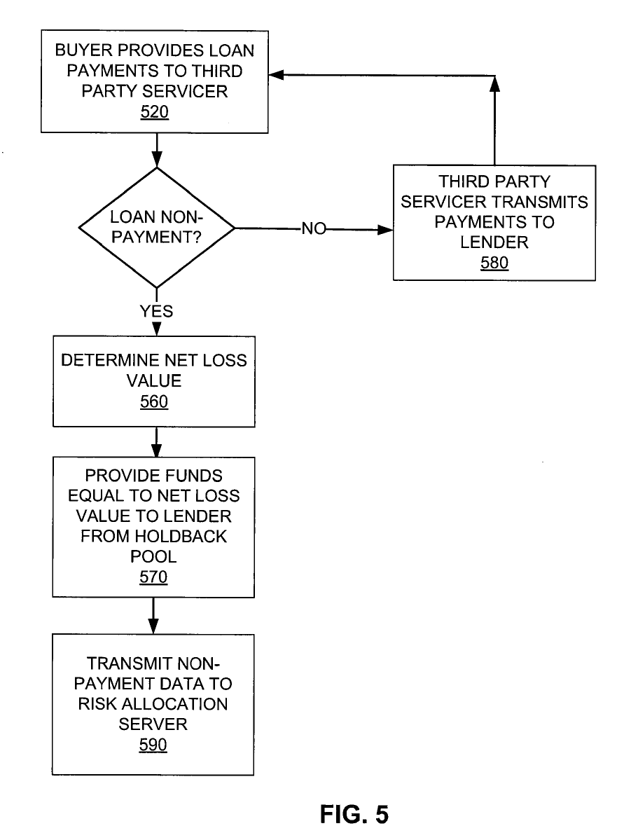

FIG. 5 is a flowchart illustrating steps performed by the buyer 120 and the loan servicer 110 to loan payment according to one embodiment. Other embodiments perform the illustrated steps in different orders, and/or perform different or additional steps. Moreover, some of the steps can be performed by entities other than the buyer 120 and loan servicer 110.

The buyer 120 provides 520 payments to the loan servicer 110 on a periodic basis specified by the terms of the loan (e.g. monthly, weekly, bi-annually). If the buyer 120 continues to provide payments, the loan servicer 110 receives the payments from the buyer 120 and transmits 580 these payments to the lender 180 until the loan is paid in full.

If there is a non-payment on the loan, in other words, a delinquency or default on behalf of the buyer 120, the financial loss value is determined 560. Typically, the loan servicer 110 determines the financial loss incurred by the lender 180 that is specific to the asset. In some embodiments, the financial loss may also be determined by the risk allocation server 150. The net loss represents the amount of funds lost due to the loan non-payment event. In one embodiment, for durable goods and homes, the financial loss is equal to the amount of outstanding principle on the loan and costs associated with the recovery and resale of the goods minus the amount of funds received from recovery and resale of the goods. In some embodiments, the financial loss for an asset is further determined based on the interest rate of the loan and the period of time necessary to resell the asset. For instance, the financial loss value for a home may be based on the outstanding principle on the loan, the amount of interest funds lost in the period of time it takes to recover and resell the home and the costs associated with the recovery and resale of the home minus the resale value of the home.

The loan servicer 110 deducts financial loss funds associated with a loan from the holdback pool 300 and provides 570 these funds and the funds obtained through recovery and resale of the goods to the lender 180. According to the embodiment, the financial loss funds may be correspond in part to the financial loss incurred by the lender 180 (i.e. a percentage of the financial loss incurred by the lender ranging from 0-100%) or may be based on a fixed amount. The loan servicer 110 transmits 590 loan information and associated financial loss values to the risk allocation server 150 for storage in the holdback pool database 442.

FIG. 6 is a flowchart illustrating steps performed by a seller 130 to contribute to a holdback pool 300 according to one embodiment. Other embodiments perform the illustrated steps in different orders, and/or perform different or additional steps. Moreover, some of the steps can be performed by entities other than the seller 130.

Initially, a seller 130 communicates a request 612 to the risk allocation server 150 to participate in lending risk allocation by contribution to a holdback pool 300. At this time, the risk allocation server 150 generates 614 a holdback pool 300 for the seller 130. Based on the seller 130, the risk allocation server 150 may request that the seller 130 transmit an amount of funds necessary to start a holdback pool 300. In alternate embodiments, the holdback pool 300 may be associated with multiple lenders 180 or sellers 130. As loans requiring risk allocation are granted to buyers 120 through the seller 130, the seller 130 contributes 616 funds equal to the holdback values determined by the risk allocation server 150 to the holdback pool 300. After a pre-defined period, the risk allocation server 150 closes 618 the holdback pool 300 and generates 614 a new holdback pool 300 for the seller 130. The pre-defined period may be based on an amount of time specified or a maximum number of loans to include in a holdback pool 300. In alternate embodiments, the holdback pool 300 may remain open indefinitely. The risk allocation server 150 determines 620 the status of the loans in the holdback pool 300, the status indicating whether the loans have been paid in full or defaulted. The risk allocation server 150 stores 622 the status of the loans in the holdback pool database 442. If funds remain in the holdback pool 300 when the status indicates all loans have been paid in full or defaulted, the seller recovers 622 the funds. In alternate embodiments, funds may be transmitted 622 from the holdback pool 300 to the seller while the pool is open or prior to all loans being paid in full or defaulted. If there are no funds remaining in the holdback pool 300, the risk allocation server 150 stores data indicating the financial loss to the lenders 180 associated with the holdback pool 300.

FIG. 7 is a flowchart illustrating steps performed by a risk allocation server 150 to generate a holdback value 302 according to one embodiment. Other embodiments perform the illustrated steps in different orders, and/or perform different or additional steps. Moreover, some of the steps can be performed by entities other than the risk allocation server.

The risk allocation server 150 receives 710 the loan application information including buyer information, dealer information and information about the good or service the loan would be used to finance. The risk allocation server 150 first determines 712 a borrower risk value based on the borrower information. The risk allocation server 150 determines 714 a dealer risk value based on the dealer information. The risk allocation server 150 further determines a financial loss value 716 based in part on the information about the good or service, buyer information and/or economic information. The risk allocation server 150 combines the dealer risk value, the financial loss value and the buyer risk value to generate 718 the holdback value 302.

The foregoing description of the embodiments of the present invention has been presented for the purposes of illustration and description. It is not intended to be exhaustive or to limit the present invention to the precise form disclosed. Many modifications and variations are possible in light of the above teaching. It is intended that the scope of the present invention be limited not by this detailed description, but rather by the claims of this application. As will be understood by those familiar with the art, the present invention may be embodied in other specific forms without departing from the spirit or essential characteristics thereof. Likewise, the particular naming and division of the modules, routines, features, attributes, methodologies and other aspects are not mandatory or significant, and the mechanisms that implement the present invention or its features may have different names, divisions and/or formats. Furthermore, as will be apparent to one of ordinary skill in the relevant art, the modules, routines, features, attributes, methodologies and other aspects of the present invention can be implemented as software, hardware, firmware or any combination of the three. Also, wherever a component, an example of which is a module, of the present invention is implemented as software, the component can be implemented as a standalone program, as part of a larger program, as a plurality of separate programs, as a statically or dynamically linked library, as a kernel loadable module, as a device driver, and/or in every and any other way known now or in the future to those of ordinary skill in the art of computer programming. Additionally, the present invention is in no way limited to implementation in any specific programming language, or for any specific operating system or environment. Accordingly, the disclosure of the present invention is intended to be illustrative, but not limiting, of the scope of the present invention, which is set forth in the following claims.

1. A computer-implemented method for processing a loan, the method comprising:
receiving an application for a loan comprising information about a buyer;
determining an amount of funds to be contributed to the holdback pool by the seller based on the information about the buyer;
receiving approval of the amount of funds from the seller; and
approving the application for the loan responsive to the approval from the seller.

2. The method of claim 1, further comprising:
determining whether the application for the loan can be approved by a loan provider without funds contributed to a holdback pool by the seller based on the information about the buyer.

3. The method of claim 2, further comprising:
determining whether the application for the loan can be approved based on lending criteria specified by the loan provider.

4. The method of claim 3, further comprising:
determining a predicted internal rate of return for the loan provider based on the lending criteria specified by the loan provider.

5. The method of claim 4, wherein determining the predicted internal rate of return for the loan provider based on the criteria specified by the loan provider comprises:
identifying historical loan information satisfying the lending criteria specified by the loan provider;
determining a lender loss value based on the historical loan information, wherein the lender loss value corresponds in part to a rate at which one or more holdback pools have had insufficient funds to repay financial loss associated with loan non-payment; and
determining the predicted rate of return for the lender based at least in part on the lender loss value.

6. The method of claim 1, wherein determining the amount of funds comprises:
determining a holdback value, the holdback value representing a financial risk associated with the loan.

7. The method of claim 6, further comprising:
determining a buyer risk value based on the information about the buyer, the buyer risk value indicating a risk of loan non-payment specific to the buyer; and
determining the holdback value based, in part, on the buyer risk value.

8. The method of claim 6, further comprising:
determining a seller risk value based on historical loan information associated with the seller, the seller risk value indicating a risk of loan non-payment specific to the seller; and
determining the holdback value based in part on the seller risk value.

9. The method of claim 6, further comprising:
determining a financial loss value based, at least in part, on the good or service, the financial loss value indicating a recovery value of the good or service; and
determining the holdback value based in part on the financial loss value.

10. The method of claim 1, further comprising:
determining an amount of funds equal to a financial loss associated with the loan responsive to loan non-payment; and
transmitting funds equal to the financial loss associated with the loan from the pool to the loan provider.

11. A computer system for processing a loan, the system comprising:
a reporting module adapted for communication with a loan provider system and the seller system; the reporting module for receiving an application for a loan comprising information about a buyer from a seller system, determining a holdback value representing a financial risk associated with the loan based on the information about the buyer and determining an amount of funds to be contributed to the holdback pool by the seller system based on the holdback value, the holdback module adapted for communication with the reporting module.

12. The system of claim 11, wherein the holdback module:
determines whether the application for the loan can be approved by a loan provider without funds contributed to a holdback pool by the seller based on the information about the buyer and lending criteria specified by the loan provider.

13. The system of claim 12, wherein the holdback module determines a predicted internal rate of return for the loan provider based on the lending criteria specified by the loan provider.

14. The system of claim 13 further comprising:
a holdback pool database adapted to communicate with the holdback module and store historic loan information; and
wherein the holdback module identifies historical loan information satisfying the lending criteria specified by the loan provider, determines lender loss values based on the historical loan information, wherein the lender loss values correspond in part to a rate at which one or more holdback pools have had insufficient funds to repay financial loss associated with loan non-payment and determine the predicted rate of return for the lender based at least in part on the lender loss values.

15. The system of claim 11, further comprising:
a risk analysis module adapted to communicate with the holdback module and determine a buyer risk value based on the information about a prospective buyer of the good or service, the buyer risk value indicating a risk of loan non-payment specific to the buyer; and
wherein the holdback module determines the holdback value based in part on the buyer risk value.

16. The system of claim 15, wherein the risk analysis module is further adapted to determine a buyer risk value based on a credit history of a prospective buyer of the good or service.

17. The system of claim 11, further comprising:
a holdback pool database for storing historic loan information, wherein the holdback pool database is adapted to communicate with the holdback module;
a pool evaluation module adapted to communicate with the holdback pool database, wherein the pool evaluation module identifies historical loan information associated with the dealer from the holdback pool database, and determines a dealer risk value based on historical loan information associated with the dealer, the dealer risk value indicating a risk of loan non-payment specific to the dealer;
and wherein the holdback module determines the holdback value based in part on the dealer risk value.

18. The system of claim 17, wherein the pool evaluation module
determines a plurality of dealer risk values based on a historic loan information indicating a plurality of pools associated with the dealer;
adjusts the plurality of dealer risk values based on dates associated with the pools; and
combines the adjusted plurality of dealer risk values to determine the dealer risk value.

19. The system of claim 11, further comprising:
a loss evaluation module for determining an expected financial loss value based on a recovery value of the good or service, wherein the loss evaluation module is adapted to communicate with the holdback module; and
wherein the holdback module:
determines the holdback value based in part on the financial loss value.

20. The system of claim 19, wherein the loss evaluation module determines the financial loss value based on the information about the prospective buyer.
